(19) United States
(12) Patent Application Publication
(10) Pub. No.: US 2020/0128137 A1
(43) Pub. Date: Apr. 23, 2020

(54) IMAGE FORMING DEVICE

(71) Applicant: SHARP KABUSHIKI KAISHA, Osaka (JP)

(72) Inventors: MASAYUKI FURUSAWA, Osaka (JP); KAZUSHI YAMANEKI, Osaka (JP); KENTA KONISHI, Osaka (JP)

(21) Appl. No.: 16/601,145

(22) Filed: Oct. 14, 2019

(30) Foreign Application Priority Data
Oct. 17, 2018 (JP) 2018-195956

(51) Int. Cl. H04N 1/00

(52) U.S. Cl. CPC H04N 1/0049; H04N 1/00474; H04N 1/00384

(57) ABSTRACT

An image forming device includes a light emission controller which controls emission of a plurality of types of light emission patterns by a plurality of light sources. The light emission controller emits each light emission pattern in response to a plurality of types of operations performed by an operator with respect to an operation portion. The light emission controller causes a light emission start timing of each of the plurality of types of light emission patterns to be different depending on the contents of the operations. The light emission controller emits first light emission patterns in response to operations performed by an operator with respect to the operation portion, emits second light emission patterns in response to a predetermined operation by the image forming device, and causes the first light emission patterns and the second light emission patterns to be different from each other in light emission end timing.

### BACKGROUND OF THE INVENTION

### Field of the Invention

The present invention relates to an image forming device such as a copier, a multifunction peripheral, a facsimile device, or a printer device. In particular, the present invention relates to an image forming device that controls the emission of a plurality of types of light emission patterns by a plurality of light sources.

### Description of the Background Art

Image forming devices that control the emission of a plurality of types of light emission patterns by a plurality of light sources are conventionally known (for example, see Japanese. Unexamined Patent. Application Publication No. 2008-233482).

Specifically, in Japanese. Unexamined Patent Application Publication No. 2008-233482, a light emission pattern (illumination pattern) is used to display the state of the image forming device or a job progress status (paragraph [0046]). More precisely, described is a light emission pattern emitted in a ready state of the image forming device, a light emission pattern emitted in an error state of the image forming device, a light emission pattern emitted in an image forming state of the image forming device, and a light emission pattern emitted in a facsimile reception state of the image forming device (paragraphs [0077] to [0082]).

In addition, an image forming device which is capable of visually representing operations performed by an operator with respect to an operation unit is sought. However, the image forming device described in Japanese Unexamined Patent Application Publication No. 2008-233482 is unable to control the emission of light emission patterns corresponding to operations performed by an operator with respect to an operation unit.

Therefore, the present invention has an object of providing an image forming device which is capable of visually representing operations performed by an operator with respect to an operation unit.

### SUMMARY OF THE INVENTION

In order to solve the above problems, the present invention provides an image forming device of a first aspect to a third aspect as follows.

(1) Image Forming Device: First Aspect

An image forming device according to a first aspect of the present invention includes a light emission controller which controls the emission of a plurality of types of light emission patterns by a plurality of light sources, wherein the light emission controller emits each light emission pattern in response to a plurality of types of operations performed by an operator with respect to an operation unit.

(2) Image Forming Device: Second Aspect

An image forming device according to a second aspect of the present invention includes a light emission controller which controls the emission of a plurality of types of light emission patterns by a plurality of light sources, wherein the light emission controller emits each light emission pattern in response to a plurality of types of operations performed by an operator with respect to an operation unit, and causes a light emission start timing of each of the plurality of types of light emission patterns to be different depending on the contents of the plurality of types of operations.

(3) Image Forming Device: Third Aspect

An image forming device according to a third aspect of the present invention includes a light emission controller which controls the emission of a plurality of types of light emission patterns by a plurality of light sources, wherein the light emission controller emits each first light emission pattern in response to a plurality of types of operations performed by an operator with respect to an operation unit, emits each second light emission pattern in response to a predetermined operation by the image forming device, and causes a light emission end timing of the relevant first light emission pattern and a light emission end timing of the relevant second light emission pattern to be different from each other.

According to the present invention, it is possible to visually represent operations performed by an operator with respect to an operation unit.

### BRIEF DESCRIPTION OF THE DRAWINGS

FIG. 1 is a front view showing, in a transparent view, a schematic configuration of an image forming device according to an embodiment of the present invention.

FIG. 2 is a perspective view showing the external appearance of an example of the image forming device according to the present embodiment.

FIG. 3 is a perspective view showing a pattern light emitter section of the image forming device shown in FIG. 1.

FIG. 4 is an exploded perspective view showing a pattern light emitter section of the image forming device shown in FIG. 1.

FIG. 5 is a front view showing a pattern light emitter section of the image forming device shown in FIG. 1.

FIG. 6 is a plan view showing an operation device in the image forming device shown in FIG. 1.

FIG. 7 is a schematic cross-sectional view showing the section surrounding the pattern light emitter as viewed from the side.

FIG. 8 is a system block diagram of a control system in the image forming device shown in FIG. 1.

FIG. 9A is a plan view of the pattern light emitter, schematically showing an example of emission of a first light emission pattern.

FIG. 9B is a plan view of the pattern light emitter, schematically showing another example of emission of the first light emission pattern.

FIG. 9C is a plan view of the pattern light emitter, schematically showing yet another example of emission of the first light emission pattern.

FIG. 9D is a plan view of the pattern light emitter, schematically showing yet another example of emission of the first light emission pattern.

FIG. 10A is an explanatory diagram for describing a light emission start timing of the first light emission pattern corresponding to an information input operation with respect to a first information input unit.

FIG. 10B is an explanatory diagram for describing a light emission start timing of the first light emission pattern corresponding to an information input, operation with respect to a second information input unit.

FIG. 10C is an explanatory diagram for describing a light emission start timing of the first light emission pattern corresponding to an information input operation with respect to a third information input unit.

FIG. 11 is a plan view of the pattern light emitter, schematically showing an example of emission of a second light emission pattern.

FIG. 12 is a flowchart (1) showing an example of a light emission control operation performed by a light emission controller.

FIG. 13 is a flowchart (2) showing an example of a light emission control operation performed by a light emission controller.

FIG. 14 is a flowchart (3) showing an example of a light emission control operation performed by a light emission controller.

### DESCRIPTION OF THE PREFERRED EMBODIMENTS

Hereunder, the embodiments of the present invention will be described with reference to the drawings. In the following description, the same components are assigned the same reference signs. The names and functions are also the same. Therefore, the detailed description of such components is not repeated.

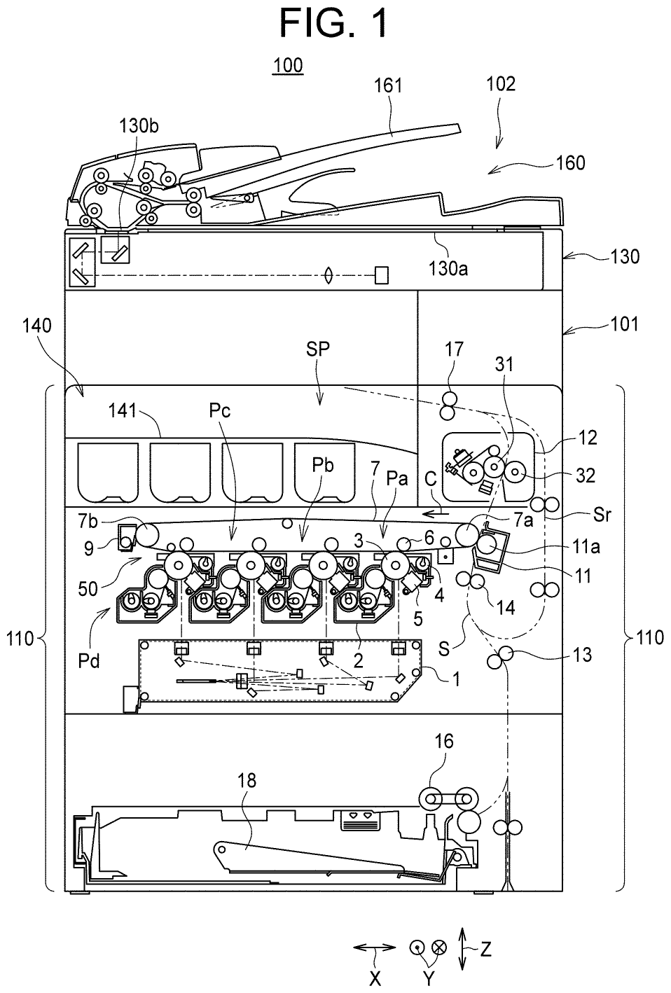

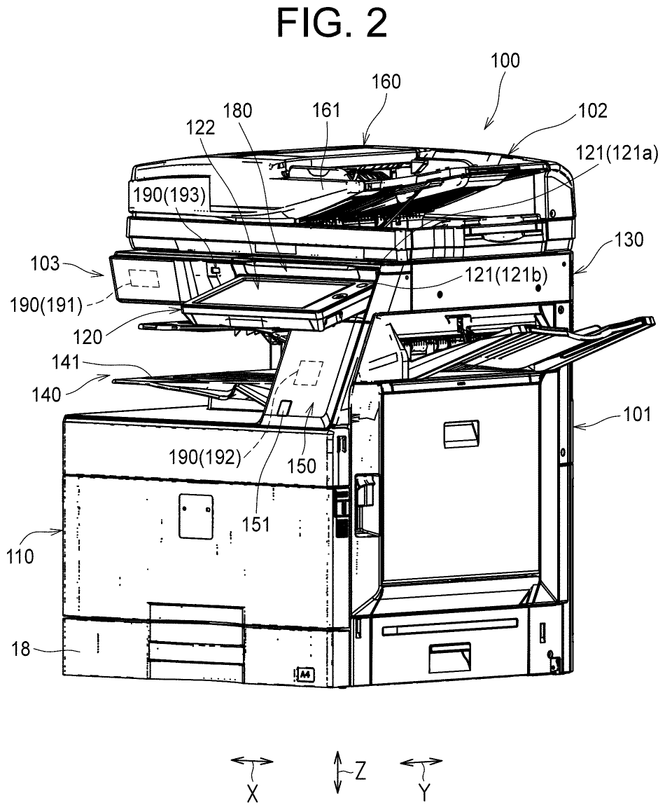

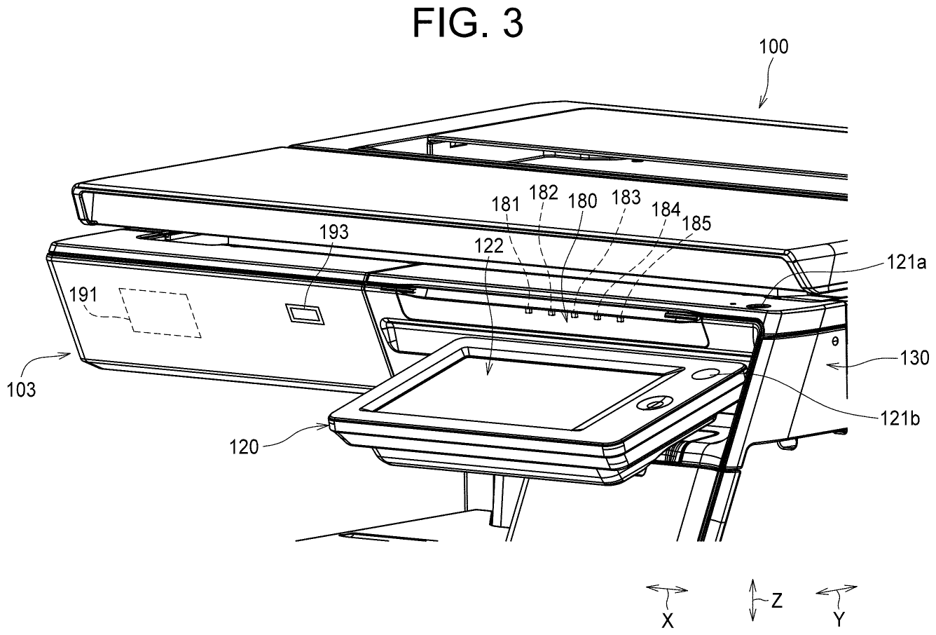

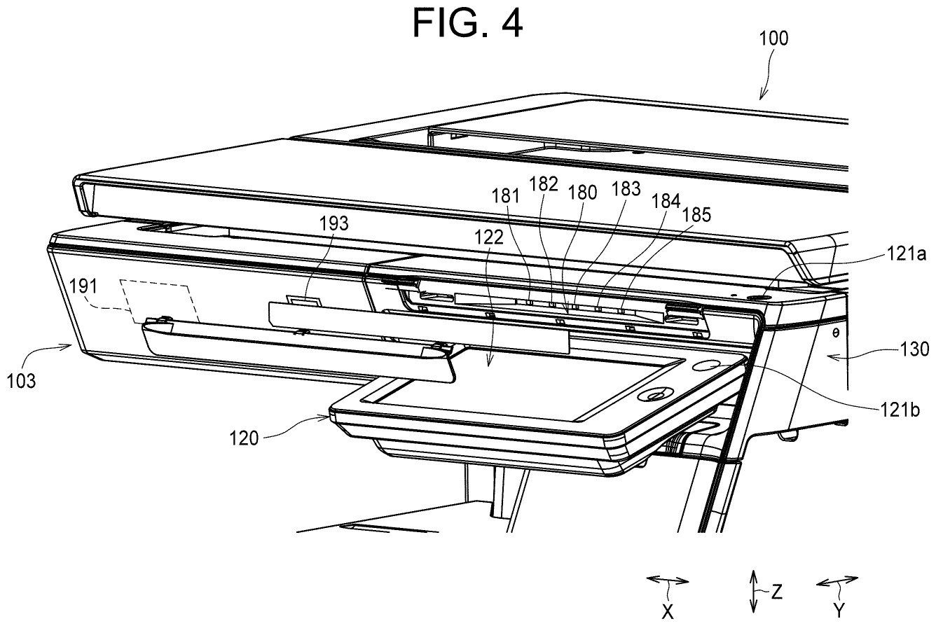

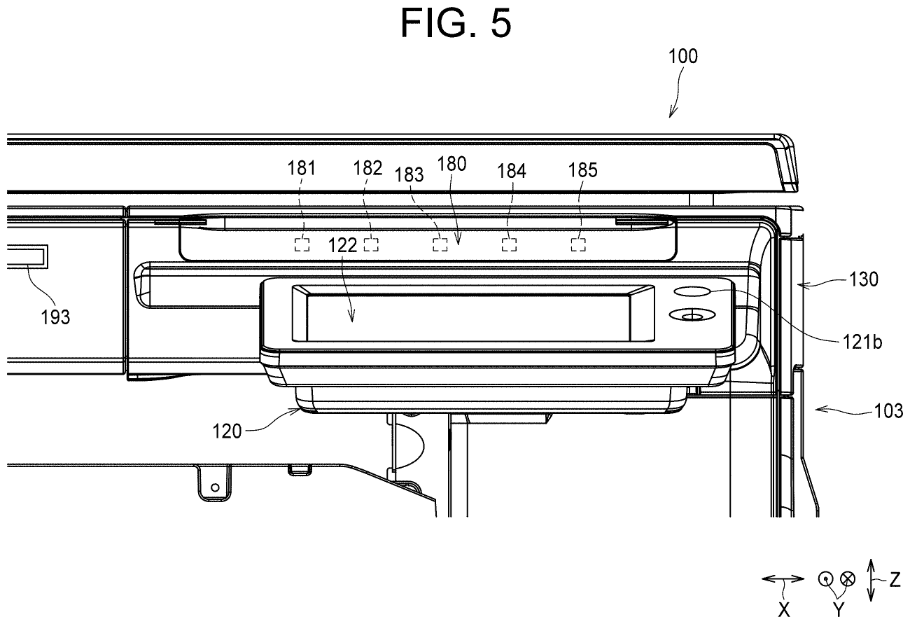

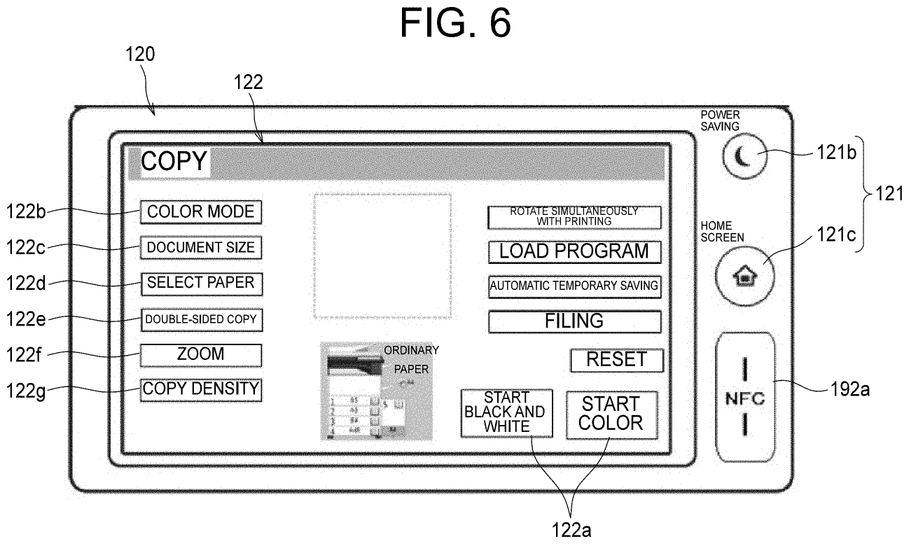

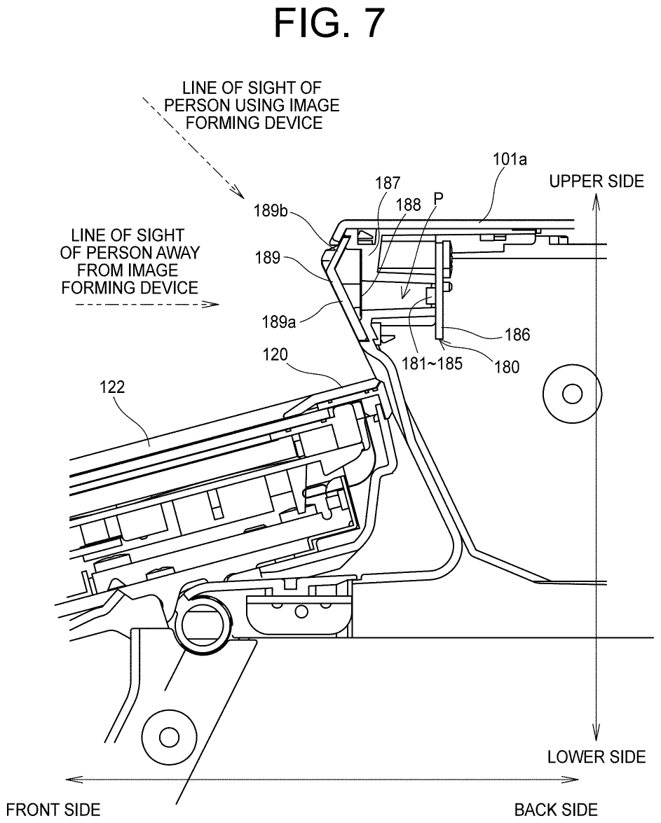

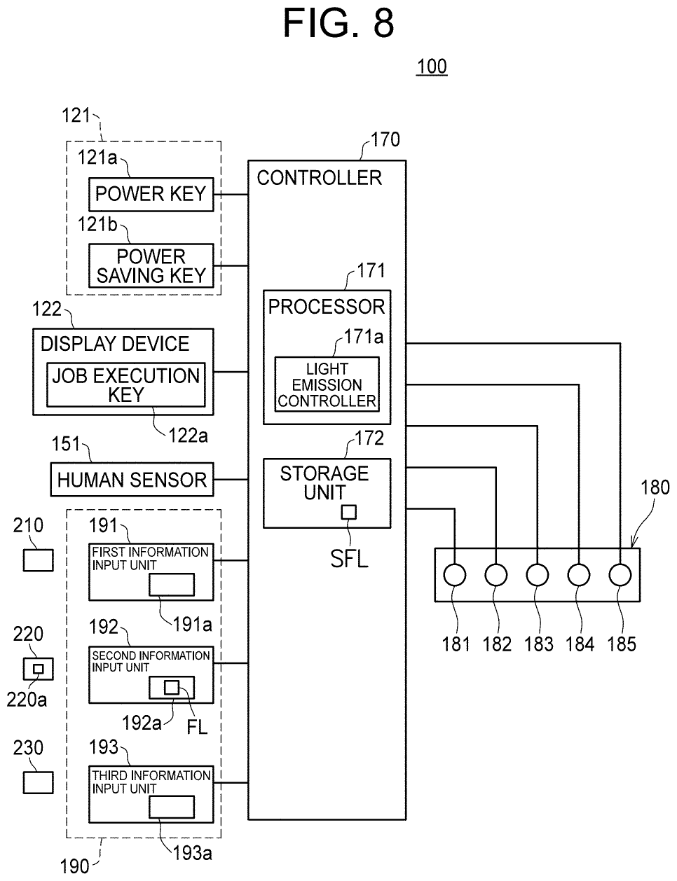

FIG. 1 is a front view showing, in a transparent view, a schematic configuration of an image forming device 100 according to an embodiment of the present, invention. FIG. 2 is a perspective view showing the external appearance of an example of an image forming device 100 according to the present embodiment. FIG. 3 and FIG. 4 are respectively perspective and exploded perspective views showing a pattern light emitter 180 section of the image forming device 100 shown in FIG. 1. FIG. 5 is a front view showing the pattern light emitter 180 section of the image forming device shown 100 in FIG. 1. FIG. 6 is a plan view showing an operation device 120 in the image forming device 100 shown in FIG. 1. FIG. 7 is a schematic cross-sectional view showing the section surrounding the pattern light emitter 180 as viewed from the side. Furthermore, FIG. 8 is a system block diagram of a control system in the image forming device 100 shown in FIG. 1. In FIG. 1 to FIG. 5, the reference sign X indicates the left-and-right direction, the reference sign Y indicates the front-and-rear direction, and the reference sign Z indicates the up-and-down direction. In FIG. 3 to FIG. 5, a portion of the image reading device 102 is not shown.

The image forming device 100 is a multifunction peripheral which includes a copy function, a scanner function, a facsimile function, and a printer function. Further, a document image read by the image reading device 102 is transmitted to the outside. Moreover, the image forming device 100 forms a color or single-color image on a paper sheet from the document image read by the image reading device 102, or an image received from the outside.

An automatic document feeder 160 (ADF), which, is supported so as to freely open and close with respect to an image reader 130, is provided above the image reader 130. In the image forming device 100, when the automatic document feeder 160 is opened, a document placement table 130a above the image reader 130 is opened so that a document can be manually placed thereon. Furthermore, the automatic document feeder 160 transports a document placed on a document tray 161 onto a document reader 130b in the image reader 130. The image reader 130 generates image data by, reading a document placed on the document placement table 130a, or by reading a document transported by the automatic document feeder 160.

The image forming device 100 includes an optical scanning device 1, a developing device 2, a photosensitive drum 3, a drum cleaning device 4, a charger 5, an intermediate transfer belt 7, a fixing device 12, a paper sheet transport path S, a paper sheet feeding cassette 18, and an internal discharge tray 141.

The image forming device 100 handles image data which corresponds to a color image using the colors black (K), cyan (W), magenta (M), and yellow (Y), or a monochrome image using a single color (such as black). An image transfer unit 50 of the image forming device 100 includes four developing devices 2, photosensitive drums 3, drum cleaning devices 4, and chargers 5 for forming four types of toner images. These components respectively configure four image stations Pa, Pb, Pc, and Pd, which are associated with black, cyan, magenta, and yellow.

The optical scanning device 1 exposes the surface of the photosensitive drum 3 to form an electrostatic latent image. The developing device 2 develops the electrostatic latent image on the surface of the photosensitive drum 3 to form a toner image on the surface of the photosensitive drum 3. The drum cleaning device 4 removes and collects residual toner on the surface of the photosensitive drum 3. The charger 5 uniformly charges the surface of the photosensitive drum 3 to a predetermined potential. As a result of the series of operations described above, a toner image of each color is formed on the surface of each photosensitive drum 3.

An intermediate transfer roller 6 is disposed above the photosensitive drum 3 via the intermediate transfer belt 7. The intermediate transfer belt 7 is stretched around a transfer driving roller 7a and a transfer driven roller 7b, and moves in a circulating fashion in the direction of arrow C. In the image forming device 100, residual toner is removed and collected by a belt cleaning device 9. The toner image of each color formed on the surfaces of the respective photosensitive drums 3 is successively transferred and superimposed on the surface of the intermediate transfer belt 7, thereby forming a color toner image.

A nip area is formed between a transfer roller 11a of a secondary transfer unit 11 and the intermediate transfer belt 7. A paper sheet transported along the paper sheet transport path S is transported by being sandwiched in the nip area. When the paper sheet passes through the nip area, the toner image on the surface of the intermediate transfer belt 7 is transferred onto the paper sheet, and is then transported to the fixing device 12.

The fixing device 12 includes a fixing roller 31 and a pressure roller 32, which rotate while sandwiching a paper sheet. The fixing device 12 sandwiches a paper sheet, which has a transferred toner image, between the fixing roller 31 and the pressure roller 32, and fixes the toner image to the paper sheet by heating and pressurizing the paper sheet.

The paper sheet feeding cassette 18 is a cassette for accumulating paper sheets used for image formation, and is provided below the optical scanning device 1. A paper sheet is drawn out from the paper sheet feeding cassette 18 by the paper sheet pickup roller 16, and is transported to the paper sheet transport path S. After being transported to the paper sheet transport path S, the paper sheet is transported via the secondary transfer unit 11 and the fixing device 12 to a paper discharge roller 17, and is discharged to the internal discharge tray 141. A transport roller 13, a registration roller 14, and the paper discharge roller 17 are disposed on the paper sheet transport path S. The transport roller 13 induces transport of the paper sheet. The registration roller 14 temporarily stops the paper sheet, and aligns the leading end of the paper sheet. The registration roller 14 transports the temporarily stopped paper sheet so as coincide with the timing of the color toner image on the intermediate transfer belt 7. The color toner image on the intermediate transfer belt 7 is transferred to the paper sheet in the nip area between the intermediate transfer belt 7 and the transfer roller 11a.

FIG. 1 shows a single paper sheet feeding cassette 18. However it is not limited to this, and a configuration may be used in which a plurality of paper sheet feeding cassettes 18 is provided, with each loaded with a different type of paper sheet.

Furthermore, if the image forming device 100 performs image formation on the rear surface as well as front surface of a paper sheet, the paper sheet is transported in an opposite direction from the paper discharge roller 17 on a paper sheet reverse path Sr. The image forming device 100 reverses the front and back surfaces of the paper sheet, which has been transported in the reverse direction, and guides the paper sheet to the registration roller 14 again. Furthermore, the image forming device 100 forms an image on the rear surface of the paper sheet guided to the registration roller 14 in the same manner as the front surface, and discharges the paper sheet into the internal discharge tray 141.

The image forming device 100 includes an image forming unit 110, an operation device 120 (operation panel), an image reader 130, a discharge unit 140, a support unit 150, an automatic document feeder 160, and a controller 170. The discharge unit 140 discharges paper sheets between the image forming unit 110 and the image reader 130. The support unit 150 supports the image reader 130 such that a space SP is provided between the image forming unit 110 and the image reader 130.

The image forming device body 101 has a substantially rectangular parallelepiped shape. The image reader 130 is provided on the upper surface of the image forming device body 101. The automatic document feeder 160 is attached onto the image reader 130. Furthermore, the operation device 120 is adjacent to the image reader 130, and is provided on the front side of the image reader 130, which is provided on the upper surface of the image forming device body 101. Here, the front side represents the operation side from which an operator operates the operation device 120. The operation device 120 is provided on an end portion in the left-and-right direction X (specifically the right side end portion) of the image reader 130. The operation device 120 has a configuration that swings (tilts) in the up-and-down direction Z With respect to the image reader 130.

### Various Keys

The operation device 120 includes various keys 121 operated by an operator, and a display device 122 (liquid crystal display device). The various keys 121 and the display device 122 are electrically connected to the controller 170. The various keys 121 (hardware keys) include a power key 121a and a power saving key 121b. The power key 121a is a key for turning on/off the supply of power to the image forming device 100 in a state where a mechanical main power supply switch (not, shown) is ON. Specifically, the power key 121a is an electrical sub-power switch, and only specific configuration elements such as a facsimile, which uses a telephone line, or an Internet facsimile function are functional when the power key 121a is turned off. The power saving key 121b is a key for turning on/off the image forming device 100 while in a standby state. When the power saving key 121b is turned on, the image forming device 100 enters a reduced energy mode that suppresses the power consumption during standby The reduced energy mode is released when the power saving key 121b is turned off.

Furthermore, a job execution key 122a (software key) (see FIG. 6) for executing jobs (copy jobs, scan jobs, and facsimile jobs) is displayed on the display screen of the display device 122 so as to be capable of receiving input operations.

In the operation device 120 shown in FIG. 6, reference symbol 121c is a hardware key, and represents a home screen key that causes switching to a home screen (initial screen). Reference symbols 122b to 122g are software keys, and respectively represent a color mode key that selects a color mode, a document size key that selects a document size, a paper sheet selection key that selects a paper sheet size, a two-sided copy key that selects a two-sided copy mode, a magnification selection key that selects a magnification, and a copy density key that selects a copy density.

### Human Sensor

A human sensor 151 that detects the presence of a person is provided on the support unit 150 of the image forming device body 101. The human sensor 151 is electrically connected to the controller 170. If the controller 170 detects that a person is present from a detection result of the human sensor 151 while in the reduced energy mode, it releases the reduced energy mode.

### Information Input Unit

Furthermore, an information input unit 190 for inputting information into the image forming device 100 is provided on the image forming device body 101. The information input unit 190 is electrically connected to the controller 170.

Specifically the information input unit 190 includes a first information input unit 191, a second information input unit 192, and a third information input unit 193. The first information input unit 191 is a non-contact type interface, and includes an IC card reader 191a for reading information stored on an IC card 210. The IC card 210 stores, for example, personal authentication information that identifies an individual. The second information input unit 192 includes an NFC (registered trademark) tag 192a (see FIG. 6 and FIG. 8). The third information input unit 193 is a connection type interface, and includes a USB port 193a for reading information stored on a USB (registered trademark) memory 230. Here, the NFC tag 192a is built into the image forming device body 101, and records, for example, wireless LAN communication setting information. An NFC tag reader 220a for reading information recorded on the NFC tag 192a is, for example, built into an NFC-compatible portable terminal 220 (typically a mobile phone). The NFC tag reader 220a of the NFC-compatible portable terminal 220 reads the wireless LAN communication setting information recorded on the NFC tag 192a in the image forming device body 101, and turns on a read completion flag FL (inventoried flag) of the NFC tag 192a.

### Operation Unit

In the image forming device 100, the operation unit 103 is constituted by the front surface of the image reader 130, the front surface of the support unit 150, and the operation device 120.

### Controller

The controller 170 is provided with a processing unit 171 comprising a microcomputer such as a CPU, and a storage unit 172 which includes a non-volatile memory such as a ROM, and a volatile memory such as a RAM. The controller 170 performs operational control of the various configuration elements as a result of the processing unit 171 loading a control program stored in advance on the ROM of the storage unit 172 onto the RAM of the storage unit 172, and then executing the program.

### Pattern Light Emitter

The pattern light emitter 180 is provided on an upper portion of the operation device 120, which is on the front surface of the image reader 130. The pattern light emitter 180 includes a plurality (five in this example) of light sources 181 to 185 (blue light emitting diodes (LEDs) in this example). The light sources 181 to 185 are provided side-by-side in the left-and-right direction X so as to emit light on the front surface side. The plurality of light sources 181 to 185 are electrically connected to the controller 170. The processing unit 171 includes a light emission controller 171a that controls the emission of a plurality of types of light emission patterns, which are mutually different combinations the plurality of light sources 181 to 185 being turned on or off.

Specifically, the pattern light emitter 180 is formed so as to horizontally extend in the left-and-right direction, and is provided on the rear side of the display device 122 in an area which includes the horizontal width of the operation device 120. That is to say, the pattern light emitter 180 is provided facing the operation device 120 (display device 122). In other words, the pattern light emitter 180 is provided directly behind the operation device 120. Furthermore, as shown in FIG. 7, the pattern light emitter 180 is provided above a hollow portion of a casing protrusion 101a.

The pattern light emitter 180 includes a substrate 186, a light guide path forming member 187, a light scattering member 188, and a filter 189. The front side surface of the substrate 186 is provided with LEDs, which represent the light sources 181 to 185 of the pattern light emitter 180. The light guide path forming member 187 forms a light guide path P.

The light scattering member 188 is a plate-shaped member, and is provided so as to cover a front surface side opening. Furthermore, relative to the midpoint between the light sources 181 to 185 and the filter 189, the light scattering member 188 is disposed on the filter 189 side in the depth direction of the device.

The filter 189 is formed of a light transmitting material which is capable of transmitting light, and transmits the light from the light scattering member 188, that is to say, the light from the light sources 181 to 185, and emits the light to the outside of the pattern light emitter 180.

Furthermore, the filter 189 has a first surface 189a and a second surface 189b. The first surface 189a and the second surface 189b are formed having a mutually different angle in the up-and-down direction. That is to say, the first surface 189a and the second surface 189b are formed so as to emit light from the light scattering member 188 in different visible directions in the up-and-down direction.

Specifically, the first surface 189a is progressively inclined to the rear side toward the bottom, and the second surface 189b is progressively inclined to the rear side toward the top. That is to say, within the front surface of the filter 189, the lower side surface facing diagonally downward is the first surface 189a, and the upper side surface facing diagonally upward is the second surface 189b.

Furthermore, the second surface 189b is provided above the first surface 189a. An upper end portion of the first surface 189a and a lower end portion of the second surface 189b are joined. That is to say when the filter 189 is viewed from the left-and-right direction, the cross-section is substantially letter-V shaped and is open on the back side (toward the rear). When a person (user) is far away from the image forming device 100, visual confirmation can be easily performed by means of the light emitted from the first surface 189a. On the other hand, because an operator (user) performs operations by standing in front of the operation device 120, visual confirmation can be easily performed by means of the light emitted from the second surface 189b. In this manner, the pattern light emitter 180 is capable of acting as a status display light for alerting a user of the status of the image forming device 100. Therefore, the visibility can be improved.

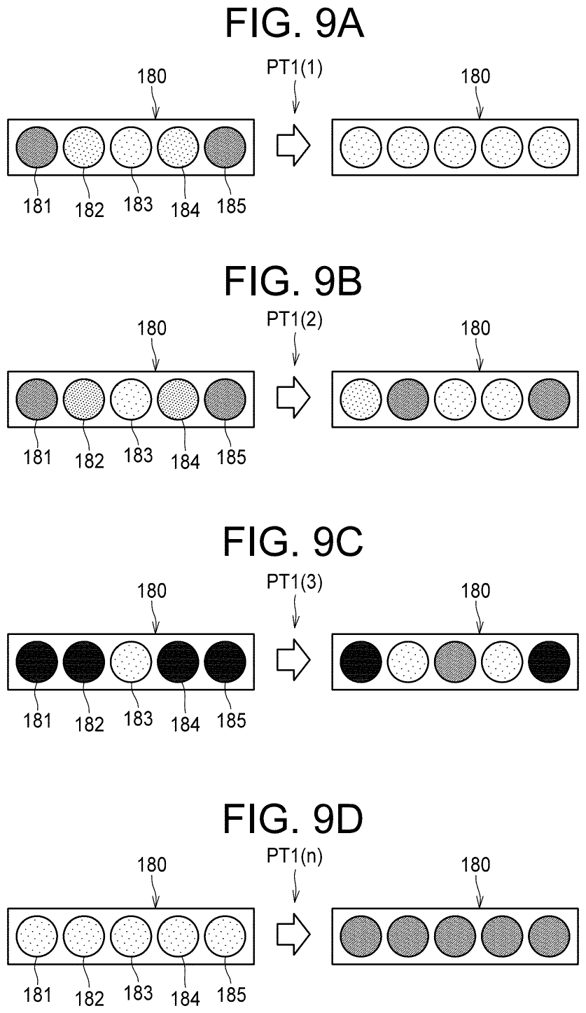

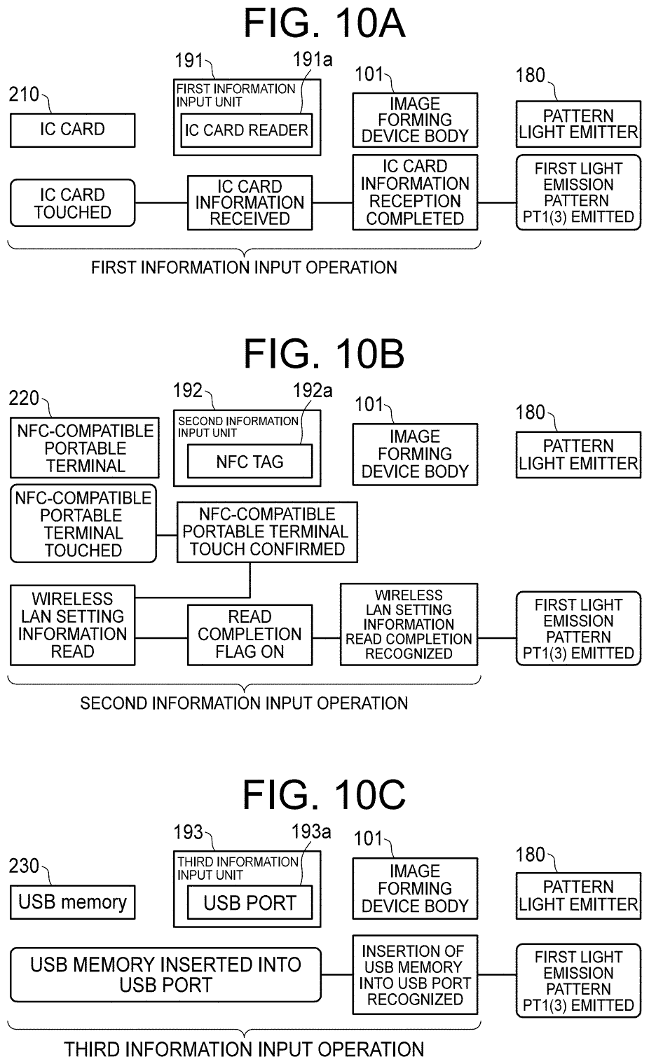

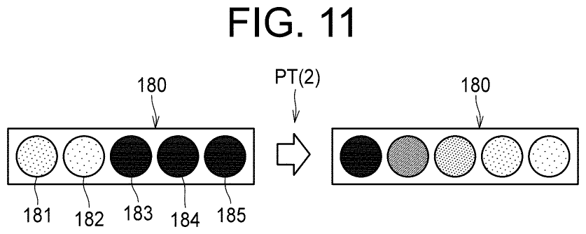

FIG. 9A to 9D are plan views of the pattern light emitter 180, schematically showing examples of the emission of first light emission patterns PT1(1) to PT1(n) (where n is an integer greater than or equal to 2, and n=4 in this example). FIG. 10A to FIG. 10C are explanatory diagrams for describing a light emission start timing of a first light emission pattern PT1(3) in response to information input operations performed with respect to a first information input unit 191 to a third information input unit 193, respectively Furthermore, FIG. 11 is a plan view of the pattern light emitter 180, schematically showing an example of emission of a second light emission pattern PT2. One cycle of the first light emission patterns PT1(1) to PT1(n) and the second light emission pattern PT2 is a predetermined fixed time period (for example, approximately two to four seconds). Furthermore, rather than being instantaneously turned on, the light sources 181 to 185 are turned on such that the brightness gradually increases. Furthermore, rather than being instantaneously turned off, the light sources 181 to 185 are turned off such that the brightness gradually decreases.

The light emission controller 171a controls the emission of a plurality of types of light emission patterns (first emission patterns PT1(1) to PT1(n)) by the plurality of light sources 181 to 185 (see FIG. 9A to FIG. 9D). The light emission controller 171a emits the respective light emission patterns in response to a plurality of types of operations performed by an operator with respect to the operation unit 103. In this manner, as a result of emitting the first light emission patterns PT1(1) to PT1(n), it is possible to visually represent, to an operator, information relating to the operations performed by an operator with respect to the operation unit 103. Moreover, the light emission controller 171a emits a second light emission pattern PT2 (see FIG. 11) representing a predetermined operation by the image forming device 100.

Furthermore, the light emission controller 171a causes the first light emission patterns PT1(1) to PT1(n) for each of the different types of operations to be different. In this manner, it is possible for an operator to recognize, for each of the plurality of types of operations, the content of the operations with respect to the operation unit 103 with certainty.

Furthermore, the light emission controller 171a causes the light emission pattern to be different for equivalent operations (for example, operation of the power key 121a) when the processing action by the image forming device 100 is different (for example, an ON operation and an OFF operation using the power key 121a). In this manner, it is possible for an operator to recognize the content of a processing action with certainty; even for equivalent operations when the processing action by the image forming device 100 is different.

### First Light Emission Pattern Shown in FIG. 9A

In the first light emission pattern PT1(1) shown in FIG. 9A, the light sources 181 to 185 are successively (randomly) turned on, simultaneously turned on, and then turned off. This represents one cycle of the first light emission pattern PT1(1). The operation performed by the operator with respect to the operation unit 103 is an ON operation of the power key 121a by an operator, or an ON operation of the power saving key 121b by an operator (a return operation from the reduced energy mode). The light emission timing of the first light emission pattern PT1(1) is at the point the power key 121a or the power saving key 121b is turned on. The first light emission pattern PT1(1) is emitted for only one cycle.

The first light emission pattern PT1(1) may be emitted when it is detected that a person is present based on the detection result from the human sensor 151. Furthermore, needless to say, an ON operation of the power key 121a or the power saving key 121b by an operator is a manual operation, and is not applicable to cases the power is turned on automatically, such as at the time of reception of a print job, or in an automatic shutdown.

### First Light Emission Pattern Shown in FIG. 9B

In the first light emission pattern PT1(2) shown in FIG. 9B, the light sources 181 to 185 are simultaneously turned on (with a successive difference in light intensity from the center), and then successively (randomly) turned off. This represents one cycle of the first light emission pattern PT1(2). The operation performed by an operator with respect to the operation unit 103 is an OFF operation of the power key 121a by an operator, or an OFF operation of the power saving key 121b by an operator (a switching, operation to the reduced energy mode). The light emission timing of the first light emission pattern PT1(2) is at the point the power key 121a or the power saving key 121b is turned off. The first light emission pattern PT1(2) is emitted for only one cycle.

An OFF operation of the power key 121a by an operator is not linked to a message displayed on a display screen on the display device 122 during image quality adjustment. For example, even if the first light, emission pattern PT1(2) shown in FIG. 9B is being emitted, a message such as “Adjusting image. Please wait” is not displayed on the display screen on the display device 122 in some cases.

### First Light Emission Pattern Shown in FIG. 9C

In the first light emission pattern PT1(3) shown in FIG. 9C, the central light source 183 among the light sources 181 to 185 is turned on, successively followed by those toward the outside such that the light expands in the left-and-right direction X (the light source 182 followed by the light source 181, and the light source 184 followed by the light source 185). Then, the light sources 183, (182 and 184), and (181 and 185) turned on previously are turned off as each of the subsequent light sources (182 and 184) and (181 and 185) are turned on. This represents one cycle of the first light emission pattern PT1(3). The operation performed by an operator with respect to the operation unit 103 is an information input operation with respect to the information input unit 190. Specifically, the information input operation with respect to the information input unit 190 is a first information input operation with respect to the IC card 210 in the first information input unit 191 (IC card reader 191a), a second information input operation with respect to the read completion flag FL in the second information input unit 192 (NFC tag 192a), or a third information input operation with respect to the USB memory 230 in the third information input unit 193 (USB port 193a). The light emission start timing of the first light emission pattern PT1(3) following a first information input operation (read operation in the IC card reader 191a) is at the point the information on the IC card 210 has been received, and reception of the information on the IC card 210 has been completed (see FIG. 10A). The light emission start timing of the first light emission pattern PT1(3) following a second information input operation (read operation in the NFC tag 192a) is at the point the read completion flag FL has been turned on, and upon recognizing read completion of the wireless LAN information (see FIG. 10B). Furthermore, the light emission start timing of the first light emission pattern PT1(3) following a third information input operation (read operation in the USB port 193a) is at the point the USB memory 230 has been inserted into the USB port 193a (see FIG. 10C). The first light emission pattern PT1(3) is emitted for only one cycle.

First Light Emission Pattern Shown in FIG. 9D

In the first light emission pattern PT1(n) shown in FIG. 9D, the light sources 181 to 185 are simultaneously turned on, and then gradually turned off with the same timing. This represents one cycle of the first light emission pattern PT1(n). The operation performed by an operator with respect to the operation unit 103 is an ON operation performed by an operator with respect to a key displayed on a display screen on the display device 122. Specifically, an ON operation with respect to the key includes a first ON operation to a third ON operation. A first ON operation is an ON operation with respect to a job execution key 122a, in which an operator instructs, from the operation device 120, the start of operation of the copy function, the scanner function, and the facsimile function. A second ON operation is an ON operation with respect to an execution key at the time of a job execution, which causes a plurality of operations to be simultaneously performed with a single key operation. A third ON operation is an ON operation performed by an operator with respect to the job execution key 122a at the time of cooperation with a cloud server, if the image forming device 100 is connected to a cloud server.

Here, the first ON operation also includes ON operations with respect to a key in various modes, such as a print image preview or a large-volume document mode (a mode that divides a read process by the automatic document feeder 160 into several parts, and then copies or transmits the document all at once). Furthermore, the first ON operation also includes ON operations performed by a user with respect keys that perform reception, printing, saving, or transferring operations by a facsimile function using a phone line, or an Internet facsimile function.

The light emission start timing of the first light emission pattern PT1(n) is for the first operation, at the point the ON operation is performed by a user with respect to the job execution key 122a. For a second operation, it is at the point the jobs associated with the plurality of operations are simultaneously performed by a single key operation. Furthermore, for the third operation, it is at the point the ON operation is performed with respect to the job execution key 122a (for example, the job execution key 122a for a print job with respect to data on a cloud server, or the job execution key 122a for a transmission job of scan data with respect to a cloud server). The first light emission pattern PT1(n) is emitted for only one cycle.

### Second Light Emission Pattern Shown in FIG. 11

In the second light emission pattern PT2 shown in FIG. 11, the light emission starts with the leftmost light source 181 among the light, sources 181 to 185 being turned on, followed in turn by those toward the right side so as to create a flowing effect. That is to say; the light sources 181, 182, 183, and 184, which turned on first, are turned off in turn each time the following light sources 182, 183, 184, and 185 are turned on. The rightmost light source 185 is turned off last. This represents one cycle of the second light emission pattern PT2. A predetermined operation by the image forming device 100 is an operation which prevents an image forming operation from being appropriately performed by the image forming device 100, or an operation which prevents the image forming operation itself from being performed. Specifically, a predetermined operation is an operation in which the image quality is automatically adjusted (image quality adjustment operation), an operation in which toner is automatically supplied to the developing device 2 (toner supplying operation), or an operation performed until the fixing device 12 reaches a predetermined fixing temperature (warmup operation). The light emission start timing of the second light emission pattern PT2 is for the image adjustment operation, at the point the image quality adjustment is performed (for example, automatic color calibration or density correction). For the toner supply operation, it is at the point the supply of toner is started. Furthermore, for the warmup operation, it is at the point where the image forming device body 101 returns from the power OFF state or the reduced energy mode state. The light emission end timing of the second light emission pattern PT2 is, for the image adjustment operation, at the point the image quality adjustment is completed. For the toner supply operation, it is at the point the supply of toner is completed. Furthermore, for the warmup operation, it is at the point the warmup is completed.

### System Settings

A setting indicating whether or not the first light emission patterns PT1(1) to PT1(n) and the second light emission pattern PT2 are emitted is performed by means of a setting flag SFL (see FIG. 8), which is set in advance with respect to the storage unit 172. For example, when the setting flag SFL is ON, the light emission controller 171a emits the first light emission patterns PT1(1) to PT1(n) and the second light emission pattern PT2. On the other hand, when the setting flag SFL is OFF, the light emission controller 171a does not emit the first light emission patterns PT1(1) to PT1(n) and the second light emission pattern PT2.

### During Simulation Mode

After the image forming device 100 enters the simulation mode, the light emission controller 171a only performs emission of the first light emission pattern PT1(3) in response to a third information input operation (read operation from the USB port 193a).

### Examples of Light Emission Control Operations Performed by Light Emission Controller

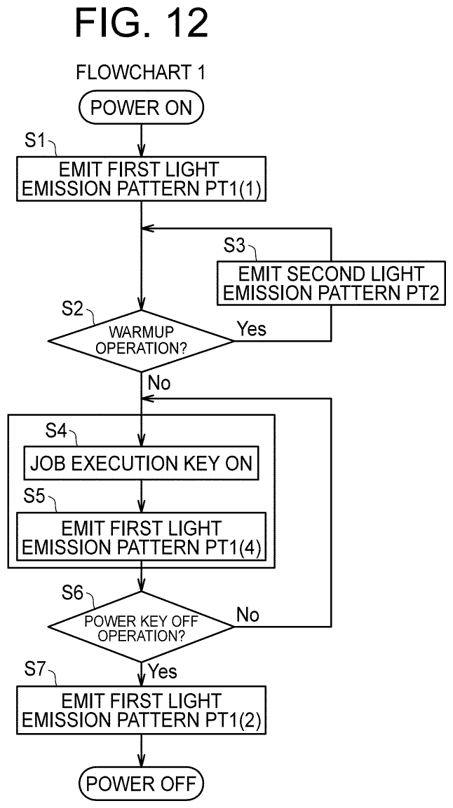

The flowcharts (1) to (3) shown in FIG. 12 to FIG. 14 represent examples of light emission control operations performed by the light emission controller 171a, which are performed when the power key 121a is turned on and until the power key 121a is turned off.

### Flowchart (1)

FIG. 12 is a flowchart (1) showing an example of a light emission control operation performed by the light emission controller 171a.

In the example of the light emission control operation shown in FIG. 12, the light emission controller 171a first emits the first light emission pattern PT1(1) for one cycle (S1). Then, the image forming device 100 determines whether or not a warmup operation is being performed (S2). If the light emission controller 171a is performing a warmup operation (S2:Yes), it emits the second light emission pattern PT2 (S3), and proceeds to S2. On the other hand, if the light emission controller 171a is not performing a warmup operation (S2:No), it proceeds to S3.

Then, as a result of the job execution key 122a being turned on (S4), the light emission controller 171a emits the first light emission pattern PT1(4) for one cycle (S5), and determines whether or not an OFF operation of the power key 121a has been performed by an operator (S6).

Next, if an OFF operation of the power key 121a has not been performed (S6:No), the light emission controller 171a proceeds to step S4. On the other hand, if an OFF operation of the power key 121a has been performed (S6:Yes), the light emission controller 171a emits the first light emission pattern PT1(2) for one cycle (S7).

### Flowchart (2)

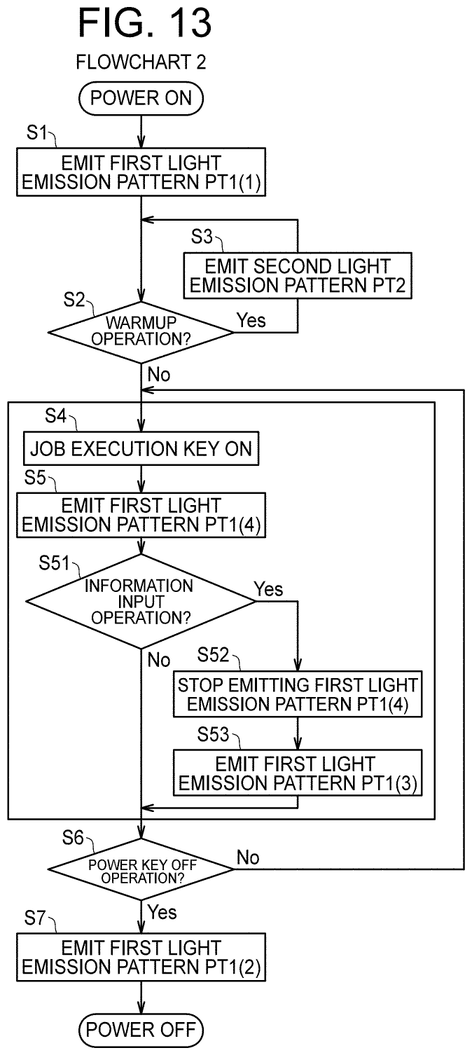

FIG. 13 is a flowchart (2) showing another example of a light emission control operation performed by the light emission controller 171a.

The flowchart (2) in FIG. 13 is different from the flowchart (1) shown in FIG. 12 in the respect that S51 to S53 have been added between S5 and S6. In the following, S51 to S53 will be mainly described.

In another example of the light emission control operation shown in FIG. 13, the light emission controller 171a emits a preceding light emission pattern PT1(4) corresponding to a previous operation (S5). Then, it determines whether or not an information input operation (a read operation by the IC card reader 191a, a read operation by the NFC tag 192a, or a read operation by the USB port 193a) exists with respect to the information input unit 190 (S51). If an information input operation does not exist (S51:No), the light emission controller 171a proceeds to S6. On the other hand, if an information input operation exists (S51:Yes), the light emission controller 171a stops emitting the preceding light emission pattern PT1(4) (S52), and emits a subsequent light emission pattern PT1(3) corresponding to the following operation for one cycle (S53). The emission of the preceding light emission pattern PT1(4) is stopped at the point the emission of the subsequent light emission pattern PT1(3) is started (at the point a light emission trigger is issued).

### Flowchart (3)

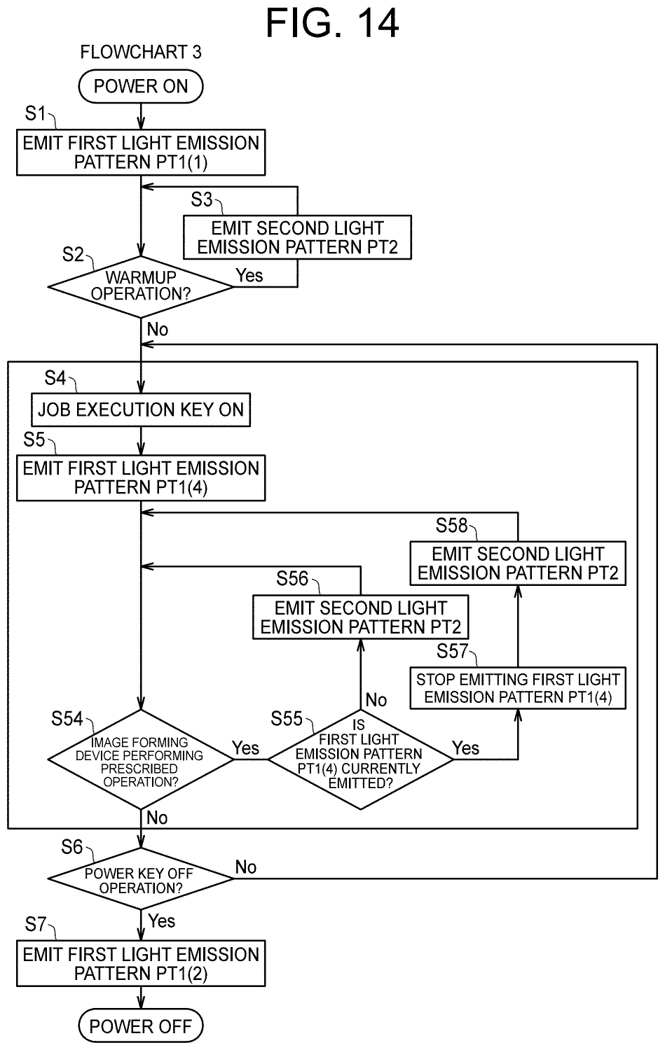

FIG. 14 is a flowchart (3) showing yet another example of a light emission control operation performed by the light emission controller 171a.

The flowchart (3) in FIG. 14 is different from the flowchart (1) shown in FIG. 12 in the respect that S54 to S58 have been added between S5 and S6. In the following, S54 to S58 will be mainly described.

In yet another example of the light emission control operation shown in FIG. 14, the light emission controller 171a emits the first light emission pattern PT1(4) (S5). Then, it determines whether or not the image forming device 100 has performed a predetermined operation (the image quality adjustment operation, the toner supplying operation, or the warmup operation) (S54). If a predetermined operation has not been performed (S54:No), the light emission controller 171a proceeds to S6. On the other hand, if a predetermined operation has been performed (S54:Yes), the light emission controller 171a determines whether or not the first light emission pattern PT1(4) is currently being emitted (S55). If the emission of the first light emission pattern PT1(4) has ended (S55:No), the light emission controller 171a emits the second light emission pattern PT2 (S56) until the image forming device 100 is no longer performing the predetermined operation (S54:No). If the first light emission pattern PT1(4) is currently being emitted (S55:Yes), the light emission controller 171a stops the emission of the first light emission pattern PT1(4) (S57). Then, it emits the second light emission pattern PT2 (S58) until the image forming device 100 is no longer performing the predetermined operation (S54:No, S55:Yes), and stops the emission of the first light emission pattern PT1(4) even after the image forming device 100 is no longer performing the predetermined operation.

### First Embodiment

In the first embodiment, the light emission controller 171a emits each light emission pattern (first light, emission patterns PT1(1) to PT1(n)) in response to a plurality of types of operations performed by an operator with respect to the operation unit 103. In this manner, as a result of emitting the first light emission patterns PT1(1) to PT1(n), it is possible to visually represent, to an operator, information relating to the operations performed by an operator with respect to the operation unit 103. In addition, if the emission of a preceding light emission pattern PT1(2) to PT1(n) corresponding to a previous operation overlaps with the emission of a subsequent, light emission pattern PT1(2) to PT1(n) corresponding to an operation performed after the previous operation, the light emission controller 171a preferentially emits, among the plurality of types of first light emission patterns, the subsequent light emission pattern PT1(2) to PT1(n) having the later light emission start timing. In this manner, it is possible for an operator to recognize that a subsequent operation with respect to the operation unit 103 has been accepted after the previous operation performed by an operator with respect to the operation unit 103 was accepted.

In the first embodiment, when the light emission controller 171a preferentially emits the subsequent light emission, pattern PT1(2) to PT1(n), it stops the emission of the preceding light emission pattern PT1(2) to PT1(n). In this manner, the light emission controller 171a is capable of avoiding mixing the emission of the subsequent light emission pattern PT1(2) to PT1(n) with the emission of the preceding light emission pattern PT1(2) to PT1(n).

In addition, if the preceding light emission pattern PT1(2) to PT1(n) is emitted after the emission of the subsequent light emission pattern PT1(2) to PT1(n), it creates a misunderstanding that the previous operation was further performed with respect to the operation unit 103 after the following operation was performed by an operator with respect to the operation unit 103.

In this respect, in the first embodiment, the light emission controller 171a stops the emission of the preceding light emission pattern PT1(2) to PT1(n) at the point the emission of the subsequent light emission pattern PT1(2) to PT1(n) is started (at the point a light emission trigger is issued). In this manner, the light emission controller 171a is capable of preventing the preceding light emission pattern PT1(2) to PT1(n) from being restored at the point the emission of the subsequent light emission pattern PT1(2) to PT1(n) is started. Consequently, it is possible to avoid a misunderstanding that the previous operation was further performed with respect to the operation unit 103 after the following operation was performed by an operator with respect to the operation unit 103.

In the first embodiment, the plurality of types of operations includes at least one of a power OFF operation for turning off the power of the image forming device 100, an information input operation for inputting information (signal or data) into the image forming device 100, and a job execution operation for executing a job. In this manner, when a power OFF operation or an information input operation is accepted during the emission of the preceding light emission pattern PT1(n), which corresponds to the job execution operation, the light emission controller 171a preferentially emits the subsequent light emission pattern PT1(2) or PT1(3) corresponding to the power OFF operation or the information input operation over the preceding light emission pattern PT1(n), which corresponds to the job execution operation. Furthermore, when a power OFF operation or a job execution operation is accepted during the emission of the preceding light emission pattern PT1(3), which corresponds to the information input operation, the light emission controller 171a preferentially emits the subsequent light emission pattern PT1(2) or PT1(n) corresponding to the power OFF operation or the job execution operation over the preceding light emission pattern PT1(3), which corresponds to the information input operation. Furthermore, when a job execution operation or an information input operation is accepted during the emission of the preceding light emission pattern PT1(2), which corresponds to the power OFF operation, the light emission controller 171a preferentially emits the subsequent light emission pattern PT1(3) or PT1(n) corresponding to the information input operation or the job execution operation over the preceding light emission pattern PT1(2), which corresponds to the power OFF operation. For example, when a power OFF operation is accepted, the light emission controller 171a is capable of starting the power OFF operation at the end of the emission of the first light emission pattern PT1(2) corresponding to the power OFF operation. In this case, when a job execution operation or an information input operation is accepted during the emission of the first light emission pattern PT1(2), which corresponds to the power OFF operation, the light emission controller 171a is capable of cancelling the power OFF operation.

### Second Embodiment

In the second embodiment, the light emission controller 171a emits the each of the plurality of types of first light emission patterns PT1(1) to PT1(n) in response to a plurality of types of operations performed by an operator with respect to the operation unit 103. In this manner, as a result of emitting the first light emission patterns PT1(1) to PT1(n), it is possible to visually represent, to an operator, information relating to the operations performed by an operator with respect to the operation unit 103. In addition, a predetermined operation by the image forming device 100 (such as the image quality adjustment operation, the toner supplying operation, and the warmup operation) is an operation that causes an operator to wait. Therefore, it is an operation which prevents an image forming operation from being be appropriately performed by the image forming device 100, or an operation which prevents the image forming operation itself from being performed. Consequently, the first light emission patterns PT1(2) to PT1(n) 180 should not emitted. In this respect, the light emission controller 171a emits the second light emission pattern PT2 representing the predetermined operation, and preferentially emits the second light emission pattern PT2 in a case where the emission of one of the types of first light emission patterns PT1(i) (where i is an integer from 2 to n) among the plurality of types of first light emission patterns PT1(2) to PT1(n) overlaps with the emission of the second light emission pattern PT2. In this manner, it is possible for an operator to recognize the predetermined operation after the operation performed by an operator with respect to the operation unit 103 has been accepted.

In addition, the emission of the second light emission pattern PT2 indicates a predetermined operation (such as the image quality adjustment operation, the toner supplying operation, and the warmup operation) which should be notified to an operator of the image forming device 100. Therefore, it is desirable ford the emission of the second light emission pattern PT2 to be continued while the predetermined operation is continued.

In this respect, in second embodiment, while the second light emission pattern PT2 is being emitted, the light emission controller 171a does not emit the first light emission patterns PT1(2) to PT1(n) (the light emission trigger is cancelled). In this manner, the light emission controller 171a is capable of not emitting the first light emission pattern PT1(2) to PT1(n) while the second light emission pattern PT2 is being emitted. As a result, the emission of the second light emission pattern PT2 can be continued while the predetermined operation is continued.

In the second embodiment, the light emission controller 171a preferentially emits the second light emission pattern PT2 while the first light emission patterns PT1(2) to PT1(n) are being emitted, and stops the emission of the first light emission patterns PT1(2) to PT1(n). In this manner, the light emission controller 171a is capable of avoiding mixing the emission of the second light emission pattern PT2 with the emission of the first light emission patterns PT1(2) to PT1(n).

In addition, if the first light emission patterns PT1(2) to PT1(n) are emitted after the emission of the second light emission pattern PT2, it creates a misunderstanding that the operation was performed by an operator with respect to the operation unit 103 after the end of the predetermined operation.

In this respect, in the second embodiment, the light emission controller 171a stops the emission of the first light emission patterns PT1(2) to PT1(n) at the point the emission of the second light emission pattern PT2 is started (at the point a light emission trigger is issued). In this manner, the light emission controller 171a is capable of preventing the first light emission pattern PT1(2) to PT1(n) from being restored at the point the emission of the second light emission pattern PT2 is started. Consequently, it is possible to avoid a misunderstanding that an operation was performed with respect to the operation unit 103 by an operator after the predetermined operation has ended.

### Third Embodiment

In the third embodiment, the light emission controller 171a emits each of the first light emission patterns PT1(1) to PT1(n) in response to a plurality of types of operations performed by an operator with respect to the operation unit 103. As a result of emitting the first light emission patterns PT1(1) to PT1(n) in this manner, it is possible to visually represent, to an operator, information relating to the operations performed by an operator with respect to the operation unit 103. In addition, the light emission controller 171a emits the second light emission pattern PT2, which indicates a predetermined operation. The plurality of types of operations includes a power ON operation of the image forming device 100. Further, even if the image forming device 100 performs a predetermined operation (for example, the image quality adjustment operation, the toner supplying operation, or the warmup operation) during warmup, it is desirable for an operator to recognize that the device is currently warming up. In this respect, in a case where, among the plurality of types of first light emission patterns PT1(1) to PT1(n), the emission of the first light emission pattern PT1(1) corresponding to the power ON operation overlaps with the emission of the second light emission pattern PT2, the light emission controller 171a preferentially emits the first light emission pattern PT1(1) corresponding to the power ON operation. In this manner, the first light emission pattern PT1(1) corresponding to the power ON operation can be emitted, even if the image forming device 100 performs a predetermined operation during warm up. Therefore, an operator is capable of recognizing that the device is currently warming up.

When the power ON operation is performed and the first light emission pattern PT1(1) corresponding to the power ON operation is emitted, power OFF operations, information input operations, and job execution operations are not accepted in the first place because the device is warming up. Therefore, the first light emission pattern PT1(1) corresponding to the power ON operation does not overlap with the first light emission patterns PT1(2) to PT1(n) corresponding to the power OFF operation, the information input operation, or the job execution operation.

In the third embodiment, when the light emission controller 171a preferentially emits the first light emission pattern PT1(1) corresponding to the power ON operation, it stops the emission of the second light emission pattern PT2. In this manner, the light, emission controller 171a is capable of avoiding mixing the emission of the first light emission pattern PT1(1) corresponding to the power ON operation with the emission of the second light emission pattern PT2.

Further, if the predetermined operation by the image forming device 100 (such as the image quality adjustment operation, the toner supplying operation, and the warmup operation) is continued after the emission of the first light emission pattern PT1(1) corresponding to the power ON operation, it is desirable for an operator to recognize that the image forming device 100 is performing the predetermined operation.

In this respect, in the third embodiment, the light emission controller 171a restarts the emission of the second light emission pattern PT2 if the predetermined operation is continued at the point that the emission of the first light emission pattern PT1(1) corresponding to the power ON operation ends (the point at which the light emission trigger is cancelled). In this manner, if the predetermined operation by the image forming device 100 is continued at the point the emission of the first light emission pattern PT(1) corresponding to the power ON operation ends, it is possible for an operator to recognize that the image forming device 100 is performing the predetermined operation.

### Fourth Embodiment

In the fourth embodiment, the light emission controller 171a emits each of the first light emission patterns PT1(1) to PT1(n) in response to a plurality of types of operations performed by an operator with respect to the operation unit 103. In this manner, as a result of emitting the first light emission patterns PT1(1) to PT1(n), it is possible to visually represent, to an operator, information relating to the operations performed by an operator with respect to the operation unit 103. In addition, the plurality of types of operations performed by an operator with respect to the operation unit 103 include operations that correspond to the first light emission pattern PT1(3) (such as an information input operation for inputting information into the image forming device 100), the emission of which is first performed after a fixed condition is satisfied after the operation, and operations that correspond to the light emission patterns PT1(1), PT1(2), and PT1(n) (such as a key input operation for performing a key input with respect to the image forming device), the emission of which may be performed immediately after the operation. Therefore, it is desirable for the plurality of types of first light emission patterns PT1(1) to PT1(n) to be emitted with an optimal light emission start timing corresponding to each of the plurality of types of operations. In this respect, the light emission controller 171a causes the light emission start timing of each of the plurality of types of first light, emission patterns PT1(1) to PT1(n) to be different, depending on the content of the plurality of types of operations. For example, for the first light emission pattern PT1(3), which corresponds to operations in which the emission is first, performed after a fixed condition is satisfied, the first light emission pattern PT1(3) is emitted after the fixed condition is satisfied after the operation. On the other hand, for the first light emission patterns PT1(1), PT1(2), and PT1(n), which correspond to operations in which the emission may be performed immediately after the operation, the first light emission patterns PT1(1), PT1(2), and PT1(n) are emitted immediately after the operation. In this manner, it is possible for the plurality of types of first light emission patterns PT1(1) to PT1(n) to be emitted with an optimal light emission start timing corresponding to each of the plurality of types of operations.

In the fourth embodiment, the plurality of types of operations includes an information input operation for inputting information into the image forming device 100. The light emission start timing of the first light emission pattern PT1(3) among the plurality of types of first light emission patterns PT1(1) to PT1(n), which corresponds to the information input operation, is at the time the input, of information by the information input operation is completed. In this manner, after the key input operation for performing a key input with respect to the image forming device 100, the first light emission pattern PT1(3) can be emitted after a fixed condition is satisfied (at the time the input of information (a signal or data) by the information input operation is completed).

In the present embodiment, the plurality of types of operations includes a key input operation for performing a key input with respect, to the image forming device 100. The light emission start timing of the first light emission patterns PT1(1), PT1(2), and PT1(n) corresponding; to the key input operation, among the plurality of types of first light emission patterns PT1(1) to PT1(n), is at the time the key input operation is accepted. In this manner, the first light emission patterns PT1(1), PT1(2), and PT1(n) can be emitted immediately after the operation (at the time the key input operation is accepted).

### Fifth Embodiment

In the fifth embodiment, the light emission controller 171a emits each of the first light emission patterns PT1(1) to PT1(n) in response to a plurality of types of operations performed by an operator with respect to the operation unit 103. In this manner, as a result of emitting the first light emission patterns PT1(1) to PT1(n), it is possible to visually represent, to an operator, information relating to the operations performed by an operator with respect to the operation unit 103. Further, the light emission controller 171a emits the second light emission pattern PT2 corresponding to a predetermined operation (such as the image quality adjustment operation, the toner supplying operation, and the warmup operation). In addition, the emission of the first light emission patterns PT1(1) to PT1(n) represents operations performed by an operator with respect to the operation unit 103 (such as a power OFF operation for turning off the power of the image forming device 100, an information input operation for inputting information into the image forming device 100, and a job execution operation for executing a job). Therefore, it is sufficient for the content of the operation to be notified to the operator for a short time (for only a predetermined fixed time period (such as one cycle)). On the other hand, the emission of the second light emission pattern PT2 indicates a predetermined operation (such as the image quality adjustment operation, the toner supplying operation, and the warmup operation) by the image forming device 100. Therefore, it is desirable for the emission of the second light emission pattern PT2 to be continued while the predetermined operation is continued. In this respect, the light emission start timing of the first light emission patterns PT1(1) to PT1(n) is different to the light emission start timing of the second light emission pattern PT2. For example, an operation performed by an operator with respect to the operation unit 103 results in the emission of the first light emission patterns PT(1) to PT1(n), which indicate the operation content to an operator, for only a predetermined fixed time period. On the other hand, a predetermined operation results in the emission of the second light emission pattern PT2, which is continued until the predetermined operation ends. In this manner, it is possible to notify the content of the operations to an operator in a short amount of time. Further, the emission of the second light emission pattern PT2 can also be continued while the predetermined operation is continued.

In the fifth embodiment, the light emission end timing of the first light emission patterns PT1(1) to PT1(n) is at the time one cycle of the first light emission patterns PT1(1) to PT1(n) ends. In this manner, it is possible to notify with certainty the content of the operations to an operator in a short amount of time.

In the fifth embodiment, the light emission end timing of the second light emission pattern PT2 is at the time the predetermined operation ends. In this manner, the emission of the second light emission pattern PT2 can be continued with certainty while the predetermined operation is continued.

In the fifth embodiment, the plurality of types of operations includes a key input operation for performing a key input with respect to the image forming device 100. The predetermined operations include at least one operation from among the toner supplying operation and the warmup operation. In this manner, a key input operation results in the emission of the first light emission patterns PT(1) to PT1(n), which indicate the operation content to an operator, for only a predetermined fixed time period. On the other hand, for at least one of the operations among the toner supplying operation and the warmup operation, the emission of the second light emission pattern PT2 corresponding to at least one of the operations among the toner supplying operation and the warmup operation, is continued until the end of at least one of the operations among the toner supplying operation and the warmup operation. In this manner, it is possible to notify the content of a key input operation to an operator in a short amount of time. Further, the emission of the second light emission pattern PT2 can also be continued while at least one of the operations among the toner supplying operation and the warmup operation is continued.

### Other Embodiments

In the present embodiment, the job execution key 122a is a software key. However, it may also be a hardware key provided with the operation unit 103. In this case, it is possible to display a light emission pattern by depressing the hardware key corresponding to the execution key Furthermore, in the present embodiment, the number of light sources is five. However, this number may be two to four, or six or more. Furthermore, in the present embodiment, the number of types of first light emission patterns PT1 is five. However, the number of types may be two to four, or six or more. Furthermore, the light emission controller 171a is capable of performing the light emission operations described above when using the copy function, the scanner function, the facsimile function, or the printer function.

The present invention is not limited to the embodiments described above, and may be implemented in a variety of other forms. Therefore, the embodiments are merely examples in all respects and should not be interpreted in a limited manner. The scope of the present invention is represented by the scope of claims, and is not restricted by the text of the specification. Further, all modifications and changes belonging to a scope equivalent to the claims are within the scope of the present invention.

What is claimed is:

1. An image forming device including a light emission controller which controls emission of a plurality of types of light emission patterns by a plurality of light sources, wherein
the light emission controller emits each light emission pattern in response to a plurality of types of operations performed by an operator with respect to an operation portion.

2. The image forming device according to claim 1, wherein
the light emission controller makes the plurality of types of light emission patterns to be different for each of the plurality of types of operations.

3. The image forming device according to claim 1, wherein
the light emission controller makes the plurality of types of light emission patterns to be different for equivalent operations when a processing action by the image forming device is different between the equivalent operations.

4. The image forming device according to claim 1, wherein
the plurality of types of operations include an information input operation for inputting information into the image forming device, and
a light emission start timing of a light emission pattern that, among the plurality of types of light emission patterns, corresponds to the information input operation is at a time when input of information by the information input operation is completed.

5. The image forming device according to claim 1, wherein
the plurality of types of operations include a key input operation for performing a key input into the image forming device, and
a light emission start timing of a light emission pattern that, among the plurality of types of light emission patterns, corresponds to the key input operation is at a time when the key input operation is accepted.

6. An image forming device including a light emission controller which controls emission of a plurality of types of light emission patterns by a plurality of light sources, wherein
the light emission controller emits each light emission pattern in response to a plurality of types of operations performed by an operator with respect to an operation portion, and causes a light emission start timing of each of the plurality of types of light emission patterns to be different depending on contents of the plurality of types of operations.

7. The image forming device according to claim 6, wherein
the plurality of types of operations include an information input operation for inputting information into the image forming device, and
a light emission start timing of a light emission pattern that, among the plurality of types of light emission patterns, corresponds to the information input operation is at a time when input of information by the information input operation is completed.

8. The image forming device according to claim 6, wherein
the plurality of types of operations include a key input operation for performing a key input into the image forming device, and
a light emission start timing of a light emission pattern that, among the plurality of types of light emission patterns, corresponds to the key input operation, is at a time when the key input operation is accepted.

9. An image forming device including a light emission controller which controls emission of a plurality of types of light emission patterns by a plurality of light sources, wherein
the light emission controller emits each first light emission pattern in response to a plurality of types of operations performed by an operator with respect to an operation portion, emits each of a plurality of types of second light emission patterns in response to a predetermined operation by the image forming device, and causes a light emission end timing of the first light emission pattern and a light emission end timing of the second light emission pattern to be different from each other.

10. The image forming device according to claim 9, wherein
the light emission end timing of the first light emission pattern is at a time when one cycle of the first light emission pattern ends.

11. The image forming device according to claim 9, wherein
the light emission end timing of the second light emission pattern is at a time when the predetermined operation has ended.

12. The image forming device according to claim 9, wherein
the plurality of types of operations include a key input operation for performing a key input into the image forming device, and the predetermined operation includes at least one of a toner supplying operation and a warmup operation.
